(19) United States
(12) Patent Application Publication
(10) Pub. No.: US 2009/0053007 A1
(43) Pub. Date: Feb. 26, 2009

(54) RETRIEVABLE TOGGLE BOLT WITH PIVOT-AND-SLIDE ENGAGEMENT

(75) Inventor: Gilad RAFAELI, Givat Haim Ichud (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: GIVAT CHAIM ICHUD, Givat Chaim Ichud (IL)

(21) Appl. No.: 12/194,585

(22) Filed: Aug. 20, 2008

Related U.S. Application Data
(60) Provisional application No. 60/956,718, filed on Aug. 20, 2007.

(51) Int. Cl. F16B 21/02

(52) U.S. Cl. 411/344

(57) ABSTRACT

A retrievable toggle bolt for mounting an object on a drywall or other hollow wall structure includes a headless bolt having a threaded shaft with a terminal portion for insertion through a hole in the drywall. A toggle is engaged by a pivot-and-slide engagement configuration with the terminal portion of the headless bolt so that the toggle is free to pivot relative to the headless bolt about a pivot axis substantially perpendicular to the direction of elongation and the pivot axis is slidingly displaceable along part of the toggle roughly parallel to the length. The pivot-and-slide engagement configuration links the toggle to as to rotate together with the headless bolt about an axis parallel to the direction of extension. The result is a toggle bolt which can be switched between an insertion/removal state and a locked state by simply turning the headless bolt through a half-turn about its axis.

### FIELD AND BACKGROUND OF THE INVENTION

The present invention relates to toggle bolts and, in particular, it concerns a retrievable toggle bolt for mounting an object on a drywall or other hollow wall structure.

Many modern building structures employ drywall or other hollow wall structures in which the front surface of the wall is part of a relatively thin board of material. The term “drywall” is used herein generically to refer to panels used to form such hollow wall structures, typically formed by gypsum sandwiched between two pieces of heavy paper, variously referred to as drywall, SHEETROCK® plasterboard, wallboard, GWB, or GYPROC®.

Hanging heavy objects on drywall is problematic because the material is easily torn and/or tends to powder under an applied load. Nails or screws inserted from one side of the drywall, and adhesive pads applied to the front surface, all have very limited load-bearing capability, and clearly insufficient for mounting heavy items such as flat-screen televisions. More effective are techniques which employ a bolt for clamping with inward pressure between the front and rear surfaces of the drywall panel. However, in many cases, the rear of the panel is not readily accessible.

For such applications, there exist many implementations of toggle bolts in which a toggle is pivotally mounted relative to a threaded collar so that it can be inserted end-on through a narrow hole in the drywall and then turn sideways to abut the inaccessible rear surface of the drywall. A bolt is then tightened relative to the collar to fasten the structure to the drywall. Examples of toggle bolts may be found in U.S. Pat. Nos. 991,426, 2,301,135, 2,532,040, 2,565,391, 3,127,807, 3,127,808, 4,406,569, 5,236,293, 6,161,999 and 6,287,065.

For the most part, toggle bolts are not retrievable, with at least the toggle being lost behind the drywall in the event that the bolt is to be removed. This is primarily due to the inability to manipulate the toggle via the engaged bolt after insertion through the wall. Where retrievability is required, various unduly complicated multi-component structures have been proposed.

There is therefore a need for simple toggle bolt structure which would provide reliable attachment of even heavy objects to a drywall and allow convenient retrieval of the toggle bolt when no longer required.

### SUMMARY OF THE INVENTION

The present invention is a retrievable toggle bolt for mounting an object on a drywall or other hollow wall structure.

According to the teachings of the present invention there is provided, a retrievable toggle bolt for mounting an object on a drywall or other hollow wall structure having a front surface, a rear surface and a hole passing from the front surface to the rear surface, the retrievable toggle bolt comprising: (a) a headless bolt having a threaded shaft extending in a direction of extension and a terminal portion for insertion through the hole in the drywall; (b) a toggle having a length; and (c) a pivot-and-slide engagement configuration deployed to engage the toggle with the terminal portion such that: (i) the toggle is free to pivot relative to the headless bolt about a pivot axis substantially perpendicular to the direction of elongation; (ii) the pivot axis is slidingly displaceable along part of the toggle substantially parallel to the length; and (iii) the toggle rotates together with the headless bolt when the headless bolt is rotated about the direction of extension.

According to a further feature of the present invention, the pivot-and-slide engagement configuration is deployed such that the pivot axis is slidingly displaceable along the toggle to reach a position adjacent to one end of the toggle, thereby allowing the toggle to pivot to an inline position substantially aligned with the direction of extension for insertion and withdrawal of the retrievable toggle bolt through the hole.

According to a further feature of the present invention, the pivot-and-slide engagement configuration includes at least one slot formed in the toggle and extending substantially parallel to the length, and at least one pin associated with the terminal portion of the headless bolt and engaged with the at least one slot.

According to a further feature of the present invention, the headless bolt includes a directional marking provided at a front end thereof and configured to provide an indication of a rotational position of the headless bolt.

According to a further feature of the present invention, the headless bolt includes a recess provided at a front end thereof and configured for engagement by a screwdriver for rotation of the headless bolt about the direction of extension.

According to a further feature of the present invention, there is also provided at least one threaded nut configured for tightening onto the headless bolt so as to fasten the retrievable toggle bolt to the drywall.

There is also provided according to the teachings of the present invention, a retrievable toggle bolt for mounting an object on a drywall or other hollow wall structure having a front surface, a rear surface and a hole passing from the front surface to the rear surface, the retrievable toggle bolt comprising: (a) a headless bolt having a threaded shaft extending in a direction of extension and a terminal portion for insertion through the hole in the drywall, the terminal portion being provided with at least one pin deployed generally perpendicular to the direction of extension; and (b) a toggle having a length and including at least one slot extending from adjacent to one end of the toggle in a direction substantially parallel to the length, wherein the at least one pin is engaged with the at least one slot, and wherein the headless bolt and the toggle are configured such that: (i) the toggle rotates together with the headless bolt when the headless bolt is rotated about the direction of extension; (ii) the toggle is free to pivot about an axis of the at least one pin; and (iii) the at least one pin is free to slide along the at least one slot.

There is also provided according to the teachings of the present invention, a method for attaching an object to a drywall or other hollow wall structure, the method comprising the steps of: (a) providing a retrievable toggle bolt comprising: (i) a headless bolt having a threaded shaft extending in a direction of extension and a terminal portion for insertion through the hole in the drywall, the terminal portion being provided with at least one pin deployed generally perpendicular to the direction of extension, and (ii) a toggle having a length and including at least one slot extending from adjacent to one end of the toggle in a direction substantially parallel to the length, wherein the at least one pin is engaged with the at least one slot so as to define a pivot-and-slide engagement configuration; (b) inserting the toggle and the terminal portion of the headless bolt through a bole in the drywall so that the toggle hangs primarily downwards from the headless bolt; (c) rotating the headless bolt through a half-turn about an axis parallel to the direction of extension so that the toggle is brought primarily above the headless bolt and slides downwards due to gravity, resulting in the headless bolt being linked to the toggle at an intermediate position along the length of the toggle; and (d) tightening at least one threaded nut onto the headless bolt without significant rotation of the headless bolt, thereby attaching the object to the drywall.

According to a further feature of the present invention, the retrievable toggle bolt is subsequently removed from the drywall by: (a) rotating the headless bolt through a half-turn about an axis parallel to the direction of extension so that the toggle slides downwards due to gravity, resulting in the headless bolt hanging primarily below headless bolt; and (b) withdrawing the headless bolt and the toggle through the hole.

### BRIEF DESCRIPTION OF THE DRAWINGS

Exemplary non-limiting embodiments of the invention are described in the following description, read with reference to the figures attached hereto. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. Thus, the invention is herein described, by way of example only, with reference to the accompanying drawings, wherein:

FIGS. 1A-1C are schematic isometric views of a retrievable toggle bolt, constructed and operative according to the teachings of the present invention, shown in an insertion state, an inserted state and a locked state, respectively;

FIGS. 2A-2C are schematic partially cut-away side views showing successive stages during deployment of the retrievable toggle bolt of FIGS. 1A-1C in a drywall;

FIG. 3 is a partial schematic isometric view of a front end of the retrievable toggle bolt of FIGS. 1A-1C;

FIG. 4 is a schematic partially cut-away side view showing the retrievable toggle bolt of FIGS. 1A-1C deployed in a drywall to support a shelf bracket;

FIGS. 5A and 5B are a front view and a schematic partially cut-away side view, respectively, showing the retrievable toggle bolt of FIGS. 1A-1C deployed in a drywall to support a hanging bracket;

FIGS. 6A-6C are schematic partially cut-away side views showing successive stages during removal of the retrievable toggle bolt of FIGS. 1A-1C from a drywall;

FIGS. 7A and 7B are schematic isometric views of a toggle and a bolt, respectively, for use in an alternative implementation of a retrievable toggle bolt, constructed and operative according to the teachings of the present invention; and

FIG. 8 is a schematic isometric view of a retrievable toggle bolt, constructed and operative according to the teachings of the present invention, formed from the toggle and bolt of FIGS. 7A and 7B, respectively.

### DESCRIPTION OF THE PREFERRED EMBODIMENTS

The present invention is a retrievable toggle bolt for mounting an object on a drywall or other hollow wall structure.

The principles and operation of retrievable toggle bolts according to the present invention may be better understood with reference to the drawings and the accompanying description.

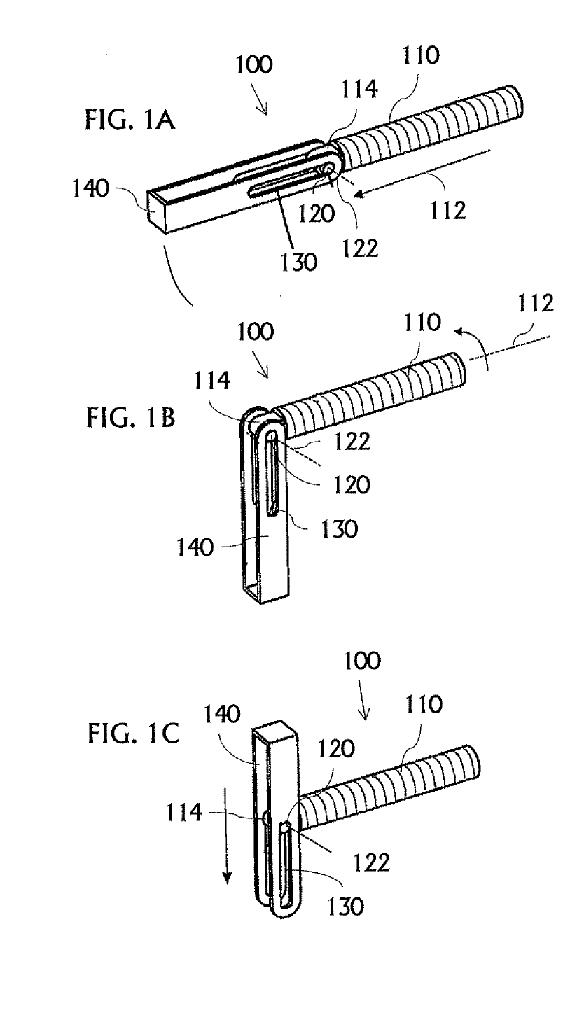

Referring now to the drawings, FIGS. 1A-6C illustrate the structure and operation of a first implementation of a retrievable toggle bolt, generally designated 100, constructed and operative according to the teachings of the present invention, for mounting an object on a drywall 160 or other hollow wall structure having a front surface 162, a rear surface 164 and a hole 166 passing therebetween.

Generally speaking, retrievable toggle bolt 100 includes a headless bolt 110 having a threaded shaft extending in a direction of extension 112 and a terminal portion 114 for insertion through the hole in the drywall. A toggle 140 is engaged with terminal portion 114 via a pivot-and-slide engagement configuration. The pivot-and-slide engagement configuration is formed such that toggle 140 is free to pivot relative to the headless bolt about a pivot axis 122 substantially perpendicular to direction of elongation 112, for example, in the pivotal motion transforming between the states of FIG. 1A and FIG. 1B. Pivot axis 122 is also slidingly displaceable along part of toggle 140 substantially parallel to the length of the toggle, for example, in the sliding displacement transforming between the states of FIG. 1B (when inverted) and FIG. 1C. The pivot-and-slide engagement configuration is however configured to interlink toggle 140 with headless bolt 110 so that toggle 140 rotates together with headless bolt 110 when headless bolt 110 is rotated about direction of extension 112.

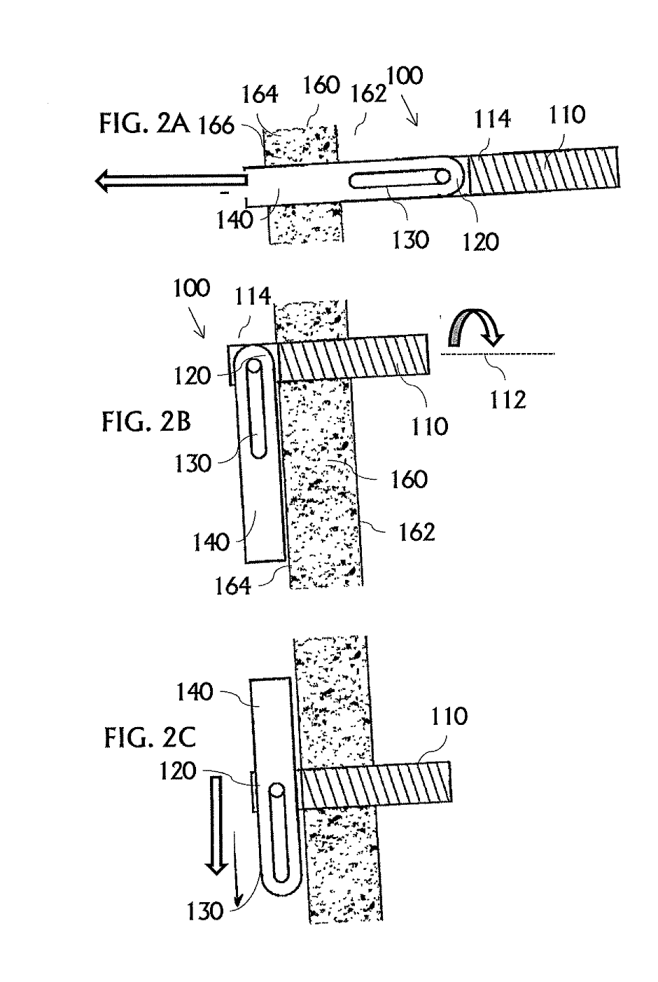

The resulting functionality of retrievable toggle bolt 100 during deployment in drywall 160 is illustrated in FIGS. 2A-2C. Toggle 140 is initially inserted through hole 166 end-on as shown in FIG. 2A until it clears the rear surface 164 of drywall 160. At this point, toggle 140 pivots downwards around pivot axis 122 due to gravity to assume the position shown in FIG. 2B. Headless bolt 110 is then turned about an axis parallel to its direction of elongation through a half-turn (180 degrees), thereby momentarily deploying toggle 140 extending upwards from terminal portion 114 (not shown). Toggle 140 then slides downwards, again under the action of gravity, until pivot axis 122 reaches a position set inwardly from both ends of toggle 140 as shown in FIG. 2C. In this state, toggle 140 is correctly deployed to provide stable abutment against rear surface 164.

At this point, various significant advantages of the present invention should already be clear. My linking toggle 140 so as to rotate together with headless bolt 110, switching of the toggle between an insertion/withdrawal state and a locked state may be achieved simply by turning headless bolt 110 through a half-turn about its axis. Furthermore, the use of a sliding point of engagement between toggle 140 and headless bolt 110 facilitates the use of a relatively short bolt which does not project more than needed from the surface of the drywall when deployed. These and other advantages of the present invention will become clearer from the remaining description taken in combination with the drawings.

Parenthetically, it will be helpful at this point to define certain terminology as used herein in the description and claims. Specifically, the term “headless bolt” is used herein in the description and claims to refer to a bolt in which the accessible end has dimensions which do not obstruct attachment of a threaded nut of dimensions suited to engage the bolt thread.

The terms “substantially parallel” and “substantially perpendicular”, unless otherwise explicitly defined, should be taken to refer to lines, axes or directions which are mutually parallel or perpendicular, respectively, within a tolerance of ±15 degrees.

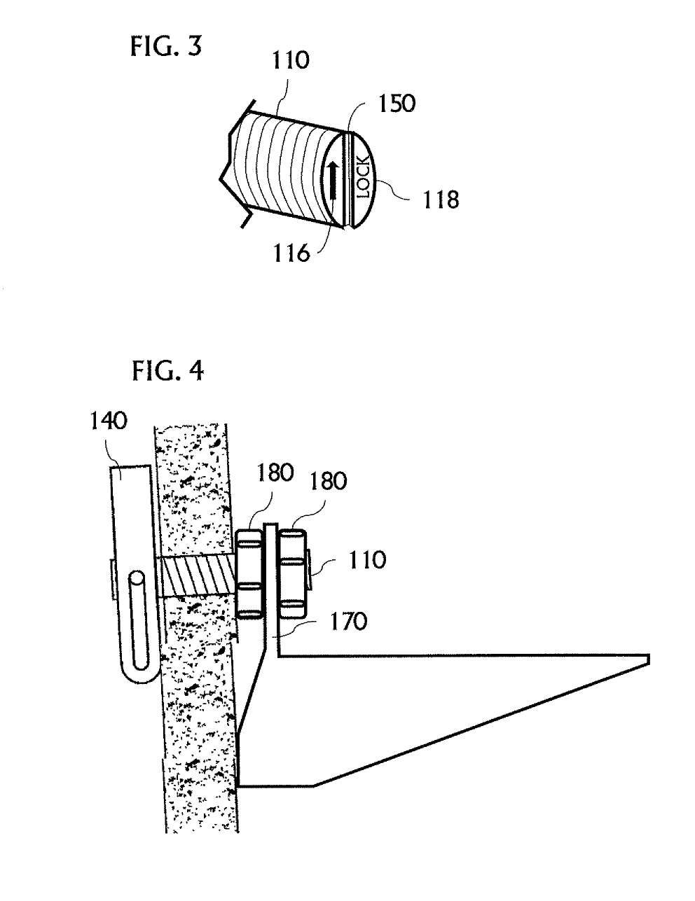

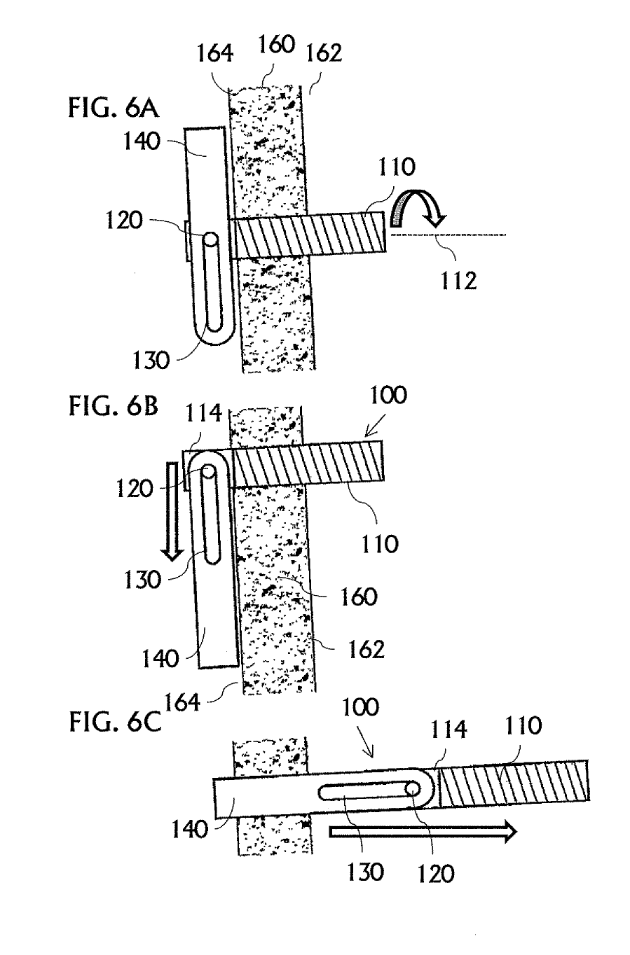

Referring to FIG. 3, there is shown a particularly preferred implementation of a front end of headless bolt 110. According to a first particularly preferred feature, headless bolt 110 includes at least one directional marking at its front end providing an indication of a rotational position of the headless bolt. In the example illustrated here, the directional markings include an arrow 116 with accompanying text 118. In this example, when arrow 116 is pointing upwards, this indicates the locked position of FIG. 2C, ready for attachment, while a downward-pointing disposition of arrow 116 indicates the unlocked position of FIG. 2B or FIG. 6B, during insertion or ready for withdrawal.

Additionally, or alternatively, the directional marking may include a recess 150 provided at the front end of headless bolt 110. A simple up-down (or side-to-side) slot is sufficient to verify that headless bolt 110 is in one of the two intended states of FIG. 2B or 2C rather than in some undefined intermediate state. These two states can readily be distinguished by pulling on headless bolt 110 to see if it is currently locked. Recess 150 preferably also serves to receive a screwdriver to facilitate rotation of headless bolt 110 about the direction of extension for deployment or retrieval of the device and/or to stabilize headless bolt 110 against rotation during tightening of a nut onto the bolt.

Turning now to FIG. 4, there is shown one exemplary form of use of retrievable toggle bolt 100 according to the teachings of the present invention. In this case, a first threaded nut 180 is tightened onto headless bolt 110, optionally with a washer (not shown), to fasten retrievable toggle bolt 100 to drywall 160. A second threaded nut 180 is then used to attach a bracket 170, in this case a shelf bracket, to headless bolt 110.

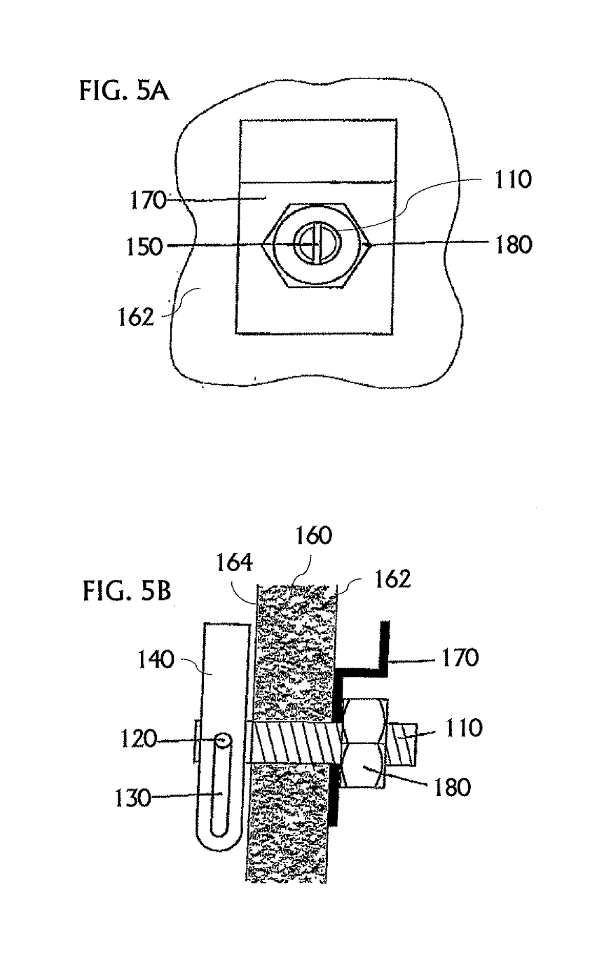

In an alternative form of use shown in FIGS. 5A and 5B, a single threaded nut 180 may be used to simultaneously fasten retrievable toggle bolt 100 to drywall 160 and attach a bracket 170, in this case, a dedicated wall-hanging bracket.

FIGS. 6A-6C illustrate the retrieval of toggle bolt 100. The sequence of retrieval is essentially the reverse of the deployment described above with reference to FIGS. 2A-2C. Specifically, after removal of any bracket 170 and fastening nuts 180, headless bolt 110 is turned about an axis parallel to its direction of elongation as illustrated in FIG. 6A through a half-turn (180 degrees). Toggle 140 then slides downwards under the action of gravity until pivot axis 122 reaches a position adjacent to the end of toggle 140 as shown in FIG. 6B. In this state, an outwards force on headless bolt 110 causes toggle 140 to bear on the edge of hole 166, thereby causing toggle 140 to pivot upwards and straighten in-line with headless bolt 110, thus allowing withdrawal of toggle bolt 100 as shown in FIG. 6C.

It will be appreciated that the aforementioned pivot-and-slide engagement configuration may be implemented in various ways. According to a set of most preferred implementations, the pivot-and-slide engagement configuration includes at least one slot 130 formed in toggle 140 and extending substantially parallel to the length of the toggle. One end of slot 130 preferably extends to adjacent one end of toggle 140, thereby facilitating straightening of toggle 140 to a position in-line with headless bolt 110. The other end of slot 130 preferably terminates at an intermediate position along the length of toggle 140, thereby defining the “locked” state of FIG. 2C. At least one pin 120, associated with terminal portion 112 of headless bolt 110, is engaged with slot 130. In the first preferred implementation illustrated in FIGS. 1A-6C, toggle 140 has a pair of parallel slots 130 each of which is engaged by a corresponding head of a pin 120 projecting from opposite sides of terminal portion 114. In order to prevent relative rotation between toggle 140 and headless bolt 110 around extensional direction 112, the part of terminal portion 114 from which the heads of pin 120 project is preferably formed as a rectangular block configured to closely engage the inward-facing surfaces of toggle 140.

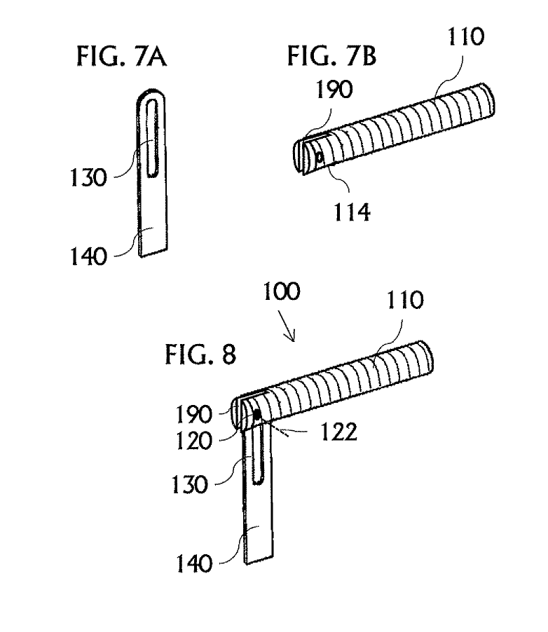

FIGS. 7A-8 show an alternative implementation of retrievable toggle bolt 100 in which toggle 140 is implemented as a flat element with a single slot 130 mounted in a channel 190 formed in terminal portion 114 and bridged by a pin 120. In all other respects, the structure and function of this implementation are fully analogous to the structure and function of the implementation of FIGS. 1A-6C.

It will be appreciated that the above descriptions are intended only to serve as examples, and that many other embodiments are possible within the scope of the present invention as defined in the appended claims.

What is claimed is:

1. A retrievable toggle bolt for mounting an object on a drywall or other hollow wall structure having a front surface, a rear surface and a hole passing from the front surface to the rear surface, the retrievable toggle bolt comprising:
(a) a headless bolt having a threaded shaft extending in a direction of extension and a terminal portion for insertion through the hole in the drywall;
(b) a toggle having a length; and
(c) a pivot-and-slide engagement configuration deployed to engage said toggle with said terminal portion such that:
(i) said toggle is free to pivot relative to said headless bolt about a pivot axis substantially perpendicular to said direction of elongation,
(ii) said pivot axis is slidingly displaceable along part of said toggle substantially parallel to said length, and
(iii) said toggle rotates together with said headless bolt when said headless bolt is rotated about said direction of extension.

2. The retrievable toggle bolt of claim 1, wherein said pivot-and-slide engagement configuration is deployed such that said pivot axis is slidingly displaceable along said toggle to reach a position adjacent to one end of said toggle, thereby allowing said toggle to pivot to an inline position substantially aligned with said direction of extension for insertion and withdrawal of the retrievable toggle bolt through the hole.

3. The retrievable toggle bolt of claim 1, wherein said pivot-and-slide engagement configuration includes at least one slot formed in said toggle and extending substantially parallel to said length, and at least one pin associated with said terminal portion of said headless bolt and engaged with said at least one slot.

4. The retrievable toggle bolt of claim 1, wherein said headless bolt includes a directional marking provided at a front end thereof and configured to provide an indication of a rotational position of said headless bolt.

5. The retrievable toggle bolt of claim 1, wherein said headless bolt includes a recess provided at a front end thereof and configured for engagement by a screwdriver for rotation of said headless bolt about said direction of extension.

6. The retrievable toggle bolt of claim 1, further comprising at least one threaded nut configured for tightening onto said headless bolt so as to fasten the retrievable toggle bolt to the drywall.

7. A retrievable toggle bolt for mounting an object on a drywall or other hollow wall structure having a front surface, a rear surface and a hole passing from the front surface to the rear surface, the retrievable toggle bolt comprising:
(a) a headless bolt having a threaded shaft extending in a direction of extension and a terminal portion for insertion through the hole in the drywall, said terminal portion being provided with at least one pin deployed generally perpendicular to said direction of extension; and
(b) a toggle having a length and including at least one slot extending from adjacent to one end of said toggle in a direction substantially parallel to said length,
wherein said at least one pin is engaged with said at least one slot, and wherein said headless bolt and said toggle are configured such that:
(i) said toggle rotates together with said headless bolt when said headless bolt is rotated about said direction of extension;
(ii) said toggle is free to pivot about an axis of said at least one pin; and
(iii) said at least one pin is free to slide along said at least one slot.

8. A method for attaching an object to a drywall or other hollow wall structure, the method comprising the steps of:
(a) providing a retrievable toggle bolt comprising:
(i) a headless bolt having a threaded shaft extending in a direction of extension and a terminal portion for insertion through the hole in the drywall, the terminal portion being provided with at least one pin deployed generally perpendicular to the direction of extension, and
(ii) a toggle having a length and including at least one slot extending from adjacent to one end of the toggle in a direction substantially parallel to the length, wherein the at least one pin is engaged with the at least one slot so as to define a pivot-and-slide engagement configuration;
(b) inserting the toggle and the terminal portion of the headless bolt through a hole in the drywall so that the toggle hangs primarily downwards from the headless bolt;
(c) rotating the headless bolt through a half-turn about an axis parallel to the direction of extension so that the toggle is brought primarily above the headless bolt and slides downwards due to gravity, resulting in the headless bolt being linked to the toggle at an intermediate position along the length of the toggle; and
(d) tightening at least one threaded nut onto the headless bolt without significant rotation of the headless bolt, thereby attaching the object to the drywall.

9. The method of claim 8, further comprising subsequently removing the retrievable toggle bolt from the drywall by:
(a) rotating the headless bolt through a half-turn about an axis parallel to the direction of extension so that the toggle slides downwards due to gravity, resulting in the headless bolt hanging primarily below headless bolt; and
(b) withdrawing the headless bolt and the toggle through the hole.
